(19) United States
(12) Patent Application Publication
(10) Pub. No.: US 2012/0011556 A1
(43) Pub. Date: Jan. 12, 2012

(54) METHOD AND APPARATUS FOR PROVIDING BROADCASTING SERVICE

(75) Inventors: Jung-Won Kang, Seoul (KR); Cong-Thang Truong, Daejeon (KR); Yong-Ju Cho, Seoul (KR); Jeong-Ju Yoo, Daejeon (KR); Jin-Woo Hong, Daejeon (KR)

(73) Assignee: ELECTRONICS AND TELECOMMUNICATIONS RESEARCH INSTITUTE, Daejon (KR)

(21) Appl. No.: 13/144,834

(22) PCT Filed: Jan. 15, 2010
(86) PCT No.: PCT/KR2010/000269

§ 371 Date: Jul. 15, 2011

Related U.S. Application Data
(60) Provisional application No. 61/145,103, filed on Jan. 15, 2009.
(60) Provisional application No. 61/219,488, filed on Jun. 23, 2009.

(30) Foreign Application Priority Data
Dec. 18, 2009 (KR) 10-2009-0127492

(51) Int. Cl. H04N 7/173

(52) U.S. Cl. 725/113; 725/109

(57) ABSTRACT

A method for providing a broadcasting service containing contents includes: generating contents representations metadata for describing possible representations of the contents; and outputting the contents representations metadata, wherein the contents representations metadata includes one or more contents representations description elements which describe a metadata tool defined by a standard specification.

### TECHNICAL FIELD

The present invention relates to a method and apparatus for providing a broadcasting service.

### BACKGROUND ART

Digital broadcasting refers to a service which transmits texts, pictures, graphics, audios, videos, program packages, and other multimedia data to terminals, such as set-top boxes, computers, and mobile phones, at ultra-high speed. Digital broadcasting provides TV programs and information related thereto, living information, Internet connection, electronic commerce, bi-directional entertainment, and so on with the use of communication media, such as a terrestrial wave and a satellite wave.

Internet Protocol Television (IPTV) has heterogeneity in itself in view of contents, networks, terminals, and users. The recent trend, called Universal Multimedia Access (UMA), relates to contents adaptation for meeting various limitations of heterogeneity. Under such backgrounds, many standards (MPEG-21, SVC, etc.) and adaptation methods have been developed.

Service discovery is an important procedure which provides sufficient information on services and contents in order for users to select and consume their desired contents. In particular, it is necessary to take into consideration the service discovery in the context of UMA. In order to enable users to search and select content items transmittable to their terminals, a commonly usable means is required which provides sufficient information on content representations and adaptation capabilities.

### DISCLOSURE OF INVENTION

### Technical Problem

An embodiment of the present invention is directed to a method and apparatus for providing a broadcasting service, which enable users to appropriately select and consume services and contents suitable for a terminal consumption environment in a heterogeneous network environment.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### Solution to Problem

In accordance with an embodiment of the present invention, a method for providing a broadcasting service containing contents includes: generating content representations metadata for describing possible representations of the contents; and outputting the content representations metadata, wherein the content representations metadata includes one or more content representations description elements which describe a metadata tool defined by a standard specification.

In accordance with another embodiment of the present invention, a method for providing a broadcasting service containing contents from a service provider to a user includes: generating an adaptation capabilities metadata for describing content adaptation capabilities of the service provider; and outputting the adaptation capabilities metadata, wherein the adaptation capabilities metadata includes at least one of a transmutation capability element, an adjustment capability element, a translation capability element, and an addition capability element.

In accordance with another embodiment of the present invention, an apparatus for providing a broadcasting service containing contents includes: a metadata generation unit configured to generate content representations metadata for describing possible representations of the contents; and an output unit configured to output the content representations metadata, wherein the content representations metadata includes one or more content representations description elements which describe a metadata tool defined by a standard specification.

In accordance with another embodiment of the present invention, an apparatus for providing a broadcasting service containing contents from a service provider to a user includes: a metadata generation unit configured to generate an adaptation capabilities metadata for describing contents adaptation capabilities of the service provider; and an output unit configured to output the adaptation capabilities metadata, wherein the adaptation capabilities metadata includes at least one of a transmutation capability element, an adjustment capability element, a translation capability element, and an addition capability element.

In accordance with another embodiment of the present invention, a method for consuming a broadcasting service containing contents includes: receiving contents representations metadata for describing possible representations of the contents; and selecting contents to be provided to a user by using the content representations metadata, wherein the content representations metadata includes one or more content representations description elements which describe a metadata tool defined by a standard specification.

In accordance with another embodiment of the present invention, a method for consuming a broadcasting service containing contents includes: receiving an adaptation capabilities metadata for describing contents adaptation capabilities of a service provider; and selecting contents to be provided to a user by using the adaptation capabilities metadata, wherein the adaptation capabilities metadata includes at least one of a transmutation capability element, an adjustment capability element, a translation capability element, and an addition capability element.

In accordance with another embodiment of the present invention, an apparatus for consuming a broadcasting service containing contents includes: an input unit configured to receive contents representations metadata for describing possible representations of the contents; and a control unit configured to select contents to be provided to a user by using the contents representations metadata, wherein the contents representations metadata includes one or more contents representations description elements which describe a metadata tool defined by a standard specification.

In accordance with another embodiment of the present invention, an apparatus for consuming a broadcasting service containing contents includes: an input unit configured to receiving an adaptation capabilities metadata for describing contents adaptation capabilities of a service provider; and a control unit configured to select contents to be provided to a user by using the adaptation capabilities metadata, wherein the adaptation capabilities metadata includes at least one of a transmutation capability element, an adjustment capability element, a translation capability element, and an addition capability element.

### Advantageous Effects of Invention

In accordance with the exemplary embodiments of the present invention, users may appropriately select and consume services or contents suitable for the terminal consumption environment in the heterogeneous network environment.

### BRIEF DESCRIPTION OF DRAWINGS

FIG. 1 is a configuration diagram of a broadcasting system in accordance with an embodiment of the present invention.

FIG. 2 is a configuration diagram of a broadcasting system in accordance with another embodiment of the present invention.

FIG. 3 is a configuration diagram of an apparatus for providing a broadcasting service in accordance with an embodiment of the present invention.

FIG. 4 is a configuration diagram of an apparatus for consuming a broadcasting service in accordance with an embodiment of the present invention.

### MODE FOR THE INVENTION

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Exemplary embodiments of the present invention relate to a method and apparatus for providing a broadcasting service, which enable users to select services or contents consumable in their consumption environments by transmitting service or contents related information to the users.

<System Configuration and Scenario>

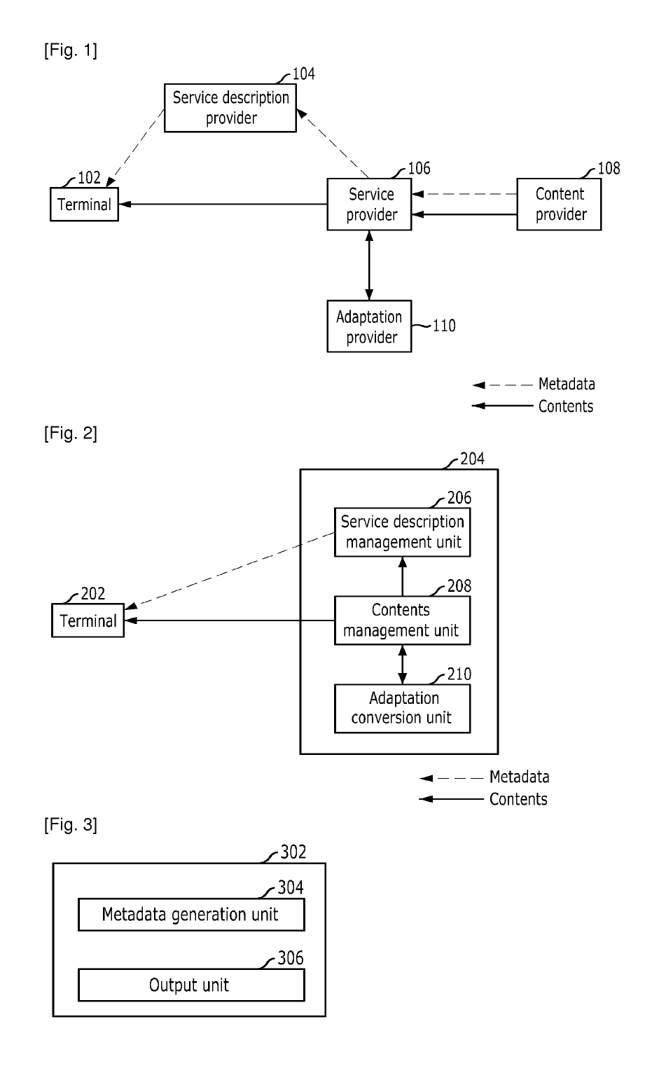

FIG. 1 is a configuration diagram of a broadcasting system in accordance with an embodiment of the present invention.

Referring to FIG. 1, a user terminal 102 receives a broadcasting service from a service provider 106. Examples of the terminal 102 may include a personal computer, a TV, a portable device, and so on, and examples of the service provider 106 may include a broadcasting station, an IPTV enterprise, and so on. The service provider 106 acquires contents from contents provider 108 and provides the acquired contents to the terminal 102.

Meanwhile, in order to transmit the contents to the user, the service provider 106 is required to adapt a corresponding contents in compliance with the restrictions of the user and the user terminal 102. An adaptation provider 110 functions to adapt the contents to be transmitted to the user by the request of the service provider 106 in compliance with the restriction of the user terminal 102.

In order to select the contents, the user must acquire service discovery information, or information on service or contents. A service description provider 104 provides the service discovery information to the user. In this context, it is important that the contents displayed to be selected by the user must be transmittable to the user. Furthermore, the service discovery information provided by the service description provider 104 may include contents representation metadata and/or adaptation capabilities metadata in accordance with the embodiment of the present invention. As illustrated in FIG. 1, the service discovery information may be generated by the contents provider 108 and transmitted to the terminal 102 through the service provider 106 and the service description provider 104. Alternatively, the service discovery information may be generated by the service provider 106 and transmitted to the terminal 102 through the service description provider 104, or may be generated by the service description provider 104 and transmitted to the terminal 102.

In the broadcasting system of FIG. 1 in accordance with the embodiment of the present invention, the service description provider 104, the service provider 106, the contents provider 108, and the adaptation provider 110 are separately provided. On the other hand, in accordance with another embodiment of the present invention, the service provider 106 may be configured to include any one of the service description provider 104, the contents provider 108, and the adaptation provider 110. Furthermore, the number of the terminal 102, the service description provider 104, the service provider 106, the contents provider 108, and the adaptation provider 110 may be changed. Specifically, when two or more service providers 106 are provided, a service provider description provider may be provided for providing information on the respective service providers 106 to the user.

FIG. 2 is a configuration diagram of a broadcasting system in accordance with another embodiment of the present invention.

Referring to FIG. 2, a terminal 202 receives a service or contents and service information from a service provider 204. The service provider 204 includes a service description management unit 206, contents management unit 208, and an adaptation unit 210.

The contents management unit 208 manages contents directly generated or received from the outside, and provides the directly generated contents or the received contents to the service description management unit 206, the adaptation unit 210, or the terminal 202.

The service description management unit 206 manages information on contents to be transmitted to the terminal 202 by the contents management unit 208, which is generated or received from the outside, and provides the generated or received contents to the terminal 202.

The adaptation unit 210, if necessary, converts the contents in compliance with restriction conditions of the terminal 202, and provides the converted contents to the contents management unit 208.

FIG. 3 is a configuration diagram of an apparatus for providing a broadcasting service in accordance with an embodiment of the present invention.

Referring to FIG. 3, the apparatus 302 for providing a broadcasting service includes a metadata generation unit 304 and an output unit 306. The metadata generation unit 304 generates contents representations metadata for describing possible representations of contents to be provided to the user. In addition, the metadata generation unit 304 generates adaptation capabilities metadata for describing contents adaptation capabilities of the service provider. The contents representations metadata or the adaptation capabilities metadata may be generated as an independent metadata, or may be included as a part of the above-described service discovery information. Therefore, the metadata generation unit 304 may generate the service discovery information.

The output unit 306 outputs the contents representations metadata, the adaptation capabilities metadata, and the service discovery information which are generated by the metadata generation unit 304. The outputted metadata or information is transmitted to the user or the user terminal through a variety of transmission means, such as an Internet network, a broadcasting network, etc.

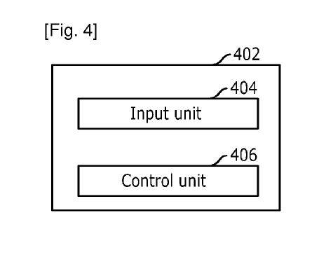

FIG. 4 is a configuration diagram of a broadcasting service consuming apparatus in accordance with an embodiment of the present invention.

The broadcasting service consuming apparatus 402 includes an input unit 404 and a control unit 406. The input unit 404 receives the contents representations metadata, the adaptation capabilities metadata, and the service discovery information which are outputted from the apparatus 302 for providing the broadcasting service. The output unit 406 selects a content to be provided to the user by using the contents representations metadata, the adaptation capabilities metadata, and the service discovery information which are inputted thereto. The selected contents may be displayed on a terminal's display as contents list which is currently usable in a terminal environment.

Hereinafter, the contents representations metadata and the adaptation capabilities metadata in accordance with the embodiment of the present invention will be described through a service scenario using the system configuration of FIG. 1.

The contents provider 108 generates a SVC video file having two space layers corresponding to QCIF and CIF resolutions, and sells the SVC video file to the service provider 106. At this time, the service discovery information (information on the generated video file) may be gathered by the service description provider 104 and provided to two users. The first user has a large terminal which can decode an MPEG-2 video format but cannot decode an SVC video format. However, the second user has a small terminal which can decode an SVC video format but has a display size and/or a processor capable of reproducing only the first space layer (i.e., the first representation having a low resolution (QCIF)).

In this case, if the service provider 106 can notify to the first user during the service discovery procedure that it can convert the SVC video format into the MPEG-2 video format the corresponding contents can be displayed on the terminal through an electronic program guide (EPG) interface or the like in order to enable the use to select the contents. If the service provider 106 does not have such a conversion capability, the corresponding contents is not displayed to the user.

In the case of the second user, if 1) the possible representations characteristic of the corresponding video (SVC layers) and 2) whether the service provider 106 has capability of extracting a specific layer from an SVC-formatted video are known during the service discovery procedure, it is determined whether to display the corresponding contents to the user through the EPG interface or the like according to such information.

It can be seen from the above exemplary service scenario that it is preferable to transmit “contents representations metadata” and “adaptation capabilities metadata” to the user in the context of UMA. In the exemplary embodiment of the present invention, the contents representations metadata may be generated by the contents provider 108 or the service provider 106, and the adaptation capabilities metadata may be provided by the service provider 106. The adaptation provider 110 may be considered as the extended concept of the service provider 106, and the service provider 106 may acquire the adaptation capabilities metadata from the adaptation provider 110 in practice.

Hereinafter, the contents representations metadata and the adaptation capabilities metadata in accordance with the embodiment of the present invention will be described in detail.

<Contents Representations Metadata>

The contents representations metadata is introduced for describing the possible representations of an original contents. For example, content having a low resolution and a high resolution with respect to the same content may be provided to a user. This is referred to as the “possible representations” of the corresponding content. Some scalable coding formats may have metadata defined as such in order to describe the possible representations (e.g., SSEI message of the SVC format).

However, in order to have common descriptions of different formats, a general syntax describing contents is more preferred. Examples of metadata tools defined in the standard specifications for such purposes may include MPEG-7 VariationSet, MPEG-21 AdaptationQoS, MPEG-21 CrossConversionQoS, etc.

Among those tools, MPEG-7 VariationSet may have a very different characteristic (e.g., type (modalities), format, etc.), and is useful for describing the already generated different representations of an original contents. On the other hand, MPEG-21 AdaptationQoS describes representations which are within the same format and are not yet generated, except the original contents. MPEG-21 CrossConversionQoS is the extension of MPEG-21 AdaptationQoS which is used to describe representations within different formats and types.

In accordance with the embodiment of the present invention, advantages of the existing tools are combined by including such metadata tools into a single “ContentsRepresentations”.

An example of the contents representations metadata, i.e., contentsRepresentations syntax, in accordance with the embodiment of the present invention, is as follows.

The meanings of the terms used in the above syntax are summarized in Table 1 below.

TABLE 1

| Term | Meaning |
|---|---|
| ContentRepresentationsType | Tool for describing the different |
| | representations of an original content item. |
| Variations | Describes different representions using |
| | VariationSet Description Scheme |
| | of ISO/IEC 15938-5. |
| ModifiedRepresentations | Describes different representions using |
| | AdaptationQoS Description Tool |
| | of ISO/IEC 21000-7. |
| ConvertedRepresentations | Describes different representions using |
| | CrossConversionQoS Description Tool |
| | of ISO/IEC 21000-7 (AMD1). |
| Uri | References to a description of content |
| | representations. |

The contents representations metadata describes the possible representations of the contents and includes one or more contents representations description elements which describe the metadata tools defined by the standard specifications. Referring to the above syntax and Table 1, the ContentsRepresentations syntax includes contents representations description elements which describe the metadata tools defined by the standard specifications such as Variations, ModifiedRepresentations, and ConvertedRepresentations.

A basic concept of such syntax is to permit the simultaneous use of one or more different metadata tools. It is apparent that only one of those metadata tools could be suitable for describing the representations of the contents item. The above-described syntax is merely exemplary, and other syntaxes may also be used for the same purpose as above.

Meanwhile, the contents representations metadata may further include an URI element for referencing to a description of the contents representations existing outside the contents representations metadata. Referring to the above syntax and Table 1, the “URI” syntax element is used to reference to a description of the contents representations already existing in other places (e.g., AdaptationQoS description already generated within the contents). Due to such an URI element, a duplicate description of the given contents item can be prevented.

For reference, a name space of a base type of the syntax described herein is merely exemplary, and may be other name space may be used.

The contents representations metadata may exist as an independent metadata, and may be linked with or included in the service discovery information. The contents representations metadata and the service discovery information may be linked through various methods. For example, an additional element having a type of ContentsRepresentations Type may be inserted into a schema of the service discovery information. As another method, the contents representations metadata may be generated in an independent record form and used for the service discovery by the IPTV. In this case, the contents representations metadata of the independent record form may require a specific identifier and a version number in order to identification and update confirmation.

<Adaptation Capabilities Metadata>

When many different representations of the single contents item are already generated, the adaptation capabilities metadata may be unnecessary. However, due to a finite storage capacity and flexibility, on-the-fly adaptation is required in practice. The adaptation capabilities metadata is used to describe adaptation methods which can be immediately performed by the service provider. The adaptation capabilities metadata will be described below through several embodiments of the present invention.

### FIRST EMBODIMENT

An example of an adaptation capabilities metadata, i.e., an AdaptationCapabilities syntax in accordance with a first embodiment of the present invention is as follows.

The terms used in the above syntax are summarized in Table 2 below.

TABLE 2

| Term | Meaning |
|---|---|
| AdaptationCapabilitesType | Tool for describing adaptation capabilities. |
| TransmutationCapability | Describes adaptation methods that convert |
| | the modality or format of a content item. |
| AdjustmentCapability | Describes adaptation methods that modify |
| | some characteristics (e.g. bitrate, resolution, |
| | constrast) of a content item, but without |
| | changing its format. |
| TranslationCapability | Describes adaptation methods that translate |
| | the language(s) of a content object (e.g. |
| | a speech, subtitle stream). |
| AdditionCapability | Describes adaptation methods that add a |
| | content object to an original object (e.g. |
| | a subtitle stream to a video content). |

As shown in Table 2, the adaptation capabilities metadata (AdaptationCapabilities Type) includes a transmutation capability element (TransmutationCapability), an adjustment capability element (AdjustmentCapability), a translation capability element (TranslationCapability), and an addition capability element (AdditionCapability).

The transmutation capability element (TransmutationCapability) describes an adaptation method such as a modality conversion or a format conversion. The adjustment capability element (AdjustmentCapability) describes an adaptation method that modifies characteristics (e.g., bitrate, resolution, contrast) of contents while maintaining a coding format of the contents. The translation capability element (TranslationCapability) describes a capability of translating different languages (e.g., a speech and a subtitle). The addition capability element (AdditionCapability) describes a capability of adding other contents object (e.g., one or more sound tracks, a subtitle stream) to an original contents.

TABLE 3

| Term | Meaning |
|---|---|
| TransmutationCapabilityType | Tool for describing adaptation methods |
| | that convert the modality or format of a |
| | content item. |
| From | Describes the original modality/format of |
| | a content item. CS's that may be used for |
| | this purpose are the ContentCS, the |
| | AudioCoding-FormatCS and the |
| | VisualCodingFormatCS defined in |
| | ISO/IEC 15938-5. |
| To | Describes the destination modality/format |
| | of a content item. CS's that may be used |
| | for this purpose are the ContentCS, the |
| | AudioCoding-FormatCS and the |
| | VisualCodingFormatCS defined in |
| | ISO/IEC 15938-5. |

As shown in Table 3 above, the transmutation capability element (TransmutationCapability) includes an original format element (From) and a destination format element (To).

TABLE 4

| Term | Meaning |
|---|---|
| AdjustmentCapabilityType | Tool for describing adaptation methods |
| | that modify some characteristics (e.g. |
| | bitrate, resolution, constrast) of a content |
| | item, but without changing its modality or |
| | format. |
| Format | Describes the format of a content item. |
| | CS's that may be used for this purpose are |
| | the AudioCodingFormatCS and the |
| | VisualCodingFormatCS defined in |
| | ISO/IEC 15938-5. |
| Operator | Describes an adaptation method applicable |
| | to this above format. A CS that may be |
| | used for this purpose is the |
| | AdaptationQoSCS defined in |
| | ISO/IEC 21000-7. |

As shown in Table 4 above, the adjustment capability element (AdjustmentCapability) includes contents format element (Format) and a conversion method element (Operator).

TABLE 5

| Term | Meaning |
|---|---|
| TranslationCapabilityType | Tool for describing adaptation methods that |
| | translate the language(s) of a content object |
| | (e.g. a speech, subtitle stream). |
| From | Describes the original language. |
| To | Describes the destination language. |
| Format | Describes the format of the language |
| | containing content (e.g. an audio format, |
| | a text format). A CS that may be used for |
| | this purpose is the AudioCodingFormatCS |
| | defined in ISO/IEC 15938-5. |

As shown in Table 5 above, the translation capability element (TranslationCapability) includes original language information (From), destination language information (To), and language format information (Format).

TABLE 6

| Term | Meaning |
|---|---|
| AdditionCapabilityType | |
| HolderFormat | Describes the format of the original content |
| | (i.e. the holder). CS's that may be used for this |
| | purpose are the ContentCS and the |
| | AudioVisualCodingFormatCS |
| | defined in ISO/IEC 15938-5. |
| AddedObject | Describes a content object to be added. |
| Format | Describes the format of the added content |
| | object. CS's that may be used for this purpose |
| | are the AudioCoding-FormatCS and the |
| | ContentCS defined in ISO/IEC 15938-5. |
| Operator | Describes a specific operation by which the |
| | content object is added to the original content |
| | (e.g. text overlaying, audio track insertion). |

As shown in Table 6 above, the addition capability element (AdditionCapability) includes holder format information (HolderFormat), added object information (AddedObject), added object format information (Format), and added operation information (Operator).

The basic concept of the above described syntax is that the service provider can notify its adaptation capabilities to the user by means of several description elements. For example, the service provider may have capability of converting a given modality (format) into one or more different modality (format), and capability of controlling one or more types with respect to contents item having a given format. Such conversion capabilities are represented by operators defined in several classification schemes (CS). Since more operators (formats and modalities) may be made, the CS must be able to be updated or newly defined. The above-described syntax may be a general holder with respect to the update that will occur later.

The adaptation capabilities metadata may exist as an independent metadata, or may be linked to or included in the service discovery information. Since methods for linking the adaptation capabilities metadata to the service discovery information are the same as those of the above-described contents representations metadata, detailed description thereof will be omitted.

### SECOND EMBODIMENT

If the CS that lists the possible transmutation methods for given modalities/formats is defined, the transmutation capability element (TransmutationCapability) of the first embodiment may be merged with the adjustment capability element (AdjustmentCapability).

An example of an adaptation capabilities metadata, i.e., an AdaptationCapabilities syntax in accordance with a second embodiment of the present invention is as follows.

The above-described syntax has an abstract CapabilityBase Type which uses a name space of MPEG-21 DIA and supports future extension.

The meanings of the terms used in the above syntax are the same as those of the terms shown in Tables 1 to 6, and the meanings of the newly added terms are given in Tables 7 to 9 below.

TABLE 7

| Term | Meaning |
|---|---|
| AdaptationCapabilitiesType | Tool for describing adaptation capabilities. |
| AdpatationCapability | Describes the capabilities of an adaptation |
| | method/tool. |

TABLE 8

| Term | Meaning |
|---|---|
| AdaptationCapabilityType | Tool for describing capabilities of an |
| | adaptation method/tool. |
| AdpatationUri | Describes the reference to an adaptation |
| | method/tool. |
| Capability | Describes a capability of the adaptation |
| | method/tool. |

TABLE 9

| Term | Meaning |
|---|---|
| CapabilityBaseType | Extends DIABaseType and provides a base abstract |
| | type for a subset of types that defines different |
| | capabilities of an adaptation tool. |

### THIRD EMBODIMENT

It is assumed that the service provider has the capability of providing prompt adaptation methods in order to provide a target service. At this time, the service provider may additionally provide information on a delay time which is taken by the adaptation method, and thus, may determine whether the contents/service navigation program/procedure is suitable for the target service of the adaptation method which is under consideration.

In other words, the service provider may provide information on the delay time, which is taken to apply the adaptation method to the contents, to the user or the user terminal, together with information on its adaptation capability. The user or the user terminal may determine whether to receive the contents by the corresponding adaptation method by using the information on the delay time.

An example of an adaptation capabilities metadata, i.e., an AdaptationCapabilities syntax in accordance with a third embodiment of the present invention is as follows.

The meanings of the terms used in the above syntax are as follows.

TABLE 10

| Term | Meaning |
|---|---|
| AdaptationCapabilityType | Tool for describing adaptation capabilities. |
| TransmutationCapability | Describes adaptation methods that convert |
| | the modality or format of a content item. |
| AdjustmentCapability | Describes adaptation methods that modify |
| | some characteristics (e.g. bitrate, resolution, |
| | constrast) of a content item, but without |
| | changing its format. |

As shown in Table 10 above, the adaptation capabilities metadata includes a trans-mutation capability element (TransmutationCapability) and an adjustment capability element (AdjustmentCapability). The adaptation capabilities metadata may further include the translation capability element (TranslationCapability) or the addition capability element (AdditionCapability) described above.

TABLE 11

| Term | Meaning |
|---|---|
| TrnasmutationCapabilityType | Describes adaptation methods that convert |
| | the modality or format of a content item. |
| From | Describes the original modality/format of |
| | a content item. CS's that may be used for |
| | this purpose are the ContentCS, the |
| | AudioCoding-FormatCS and the |
| | VisualCodingFormatCS defined in |
| | ISO/IEC 15938-5. |
| ConvertTo | Describes the destination modality/format |
| | together with processing delay information |
| | of that conversion method. |
| To | Describes the destination modality/format |
| | of a content item. CS's that may be used |
| | for this purpose are the ContentCS, the |
| | AudioCoding-FormatCS and the |
| | VisualCodingFormatCS defined in |
| | ISO/IEC 15938-5. |
| DelayExample | Describes an delay example of the |
| | corresponding conversion method. |

As shown in Table 11 above, the transmutation capability element (TransmutationCapability) includes an original format element (From), a conversion format element (ConvertTo), a destination format element (To), and a delay example element (DelayExample).

TABLE 12

| Term | Meaning |
|---|---|
| AdjustmentCapabilityType | Tool for describing adaptation methods that |
| | modify some characteristics (e.g. bitrate, |
| | resolution, constrast) of a content item, but |
| | without changing its modality or format. |
| Format | Describes the format of a content item. CS's |
| | that may be used for this purpose are the |
| | AudioCoding-FormatCS and the |
| | VisualCodingFormatCS defined in |
| | ISO/IEC 15938-5. |
| Operator | Describes an adaptation method of the given |
| | format together with processing delay |
| | information of that conversion method. |
| OperatorName | Describes an adaptation method applicable |
| | to this above format. A CS that may be used |
| | for this purpose is the AdaptationQoSCS |
| | defined in ISO/IEC 21000-7. |
| DelayExample | Describes an delay example of the |
| | corresponding conversion method. |

As shown in Table 12 above, the adjustment capability element (AdjustmentCapability) includes contents format element (Format), a conversion method element (Operator), a conversion method name element (OperatorName), and a delay example element (DelayExample).

TABLE 13

| Term | Meaning |
|---|---|
| DelayExampleType | Tool for describing the delay time of an adaptation |
| | method. |
| ExampleContent | Describes an example of content item which is |
| | created by the corresponding adaptation method |
| | and in the corresponding format/modality. |
| DelayTime | Describes a processing delay time of the given |
| | adaptation method corresponding to the given |
| | example content item. |

The basic concept of DelayExample Type shown in Table 13 above is that the delay time depends on a specific content instance or item. Therefore, each delay time may be associated with an example content item for more clarification.

As shown in Table 13 above, the delay example element (DelayExample) includes an example contents element (ExampleContents) and a delay time element (DelayTime). The example contents element describes an example of contents item which is created by a certain adaptation method to contents to be provided to the user by the service provider. The delay time element (DelayTime) describes a delay time taken to apply the adaptation method to the example contents element. The user can know whether the service provider has the conversion capability meeting the user restriction conditions through the example contents element and the delay time element. Hence, the user can determine whether to receive the corresponding contents from the service provider.

### FOURTH EMBODIMENT

The transmutation capability element, the adjustment capability element, the translation capability element, and the addition capability element included in the adaptation capabilities metadata in accordance with the embodiment of the present invention may be inserted into an existing place holder of MPEG-21 DIA ConversionCapabilityType.

An example of an adaptation capabilities metadata, i.e., an AdaptationCapabilities syntax in accordance with a fourth embodiment of the present invention is as follows.

MPEG-21 DIA ConversionCapabilityType has an empty place holder into which any syntax may be inserted. (<any namespace=“##other” processContents=“lax” minOccurs=“0”/>)

Therefore, the syntaxes of the transmutation capability element (TransmutationCapability), the adjustment capability element (AdjustmentCapability), the translation capability element (TranslationCapability), and the addition capability element (AdditionCapability) may be inserted into the place. The restrictions in this method are as follows.

1) The syntax definition of Capabilities is not specified clearly.

2) ConversionDescriptionBase Type must reference to several standardized terms defined in MPEG RDD (ISO/IEC 21000-6). This is the restriction because some adaptation systems may not use any DRM technology.

In accordance with the exemplary embodiments of the present invention, users may appropriately select and consume services or contents suitable for the terminal consumption environment in the heterogeneous network environment.

The Present application contains a subject matter related to U.S. Patent Application Nos. 61/145,103 and 61/219,488, filed on Jan. 15, 2009 and Jun. 23, 2009, respectively, and Korean Patent Application No. 10-2009-0127492, filed on Dec. 18, 2009, which are incorporated herein by reference in their entirety.

While the present invention has been described with respect to the specific embodiments, it will be apparent to those skilled in the art that various changes and modifications may be made without departing from the spirit and scope of the invention as defined in the following claims.

1. A method for providing a broadcasting service containing contents, the method comprising:
generating contents representations metadata for describing possible representations of the contents; and
outputting the contents representations metadata,
wherein the contents representations metadata comprises one or more contents representations description elements which describe a metadata tool defined by a standard specification.

2. The method of claim 1, wherein the metadata tool comprises at least one of VariationSet defined in MPEG-7, AdaptationQoS defined in MPEG-21, and CrossConversionQoS defined in MPEG-21.

3. The method of claim 1, wherein the contents representations metadata further comprises an URI element which references to a description of contents representation existing outside the contents representations metadata.

4. A method for providing a broadcasting service containing contents from a service provider to a user, the method comprising:
generating an adaptation capabilities metadata for describing contents adaptation capabilities of the service provider; and
outputting the adaptation capabilities metadata,
wherein the adaptation capabilities metadata comprises at least one of a transmutation capability element, an adjustment capability element, a translation capability element, and an addition capability element.

5. The method of claim 4, wherein the transmutation capability element comprises a delay example element which describes a delay example of a transmutation method described in the transmutation capability element.

6. The method of claim 4, wherein the transmutation capability element comprises an original format element and a destination format element.

7. The method of claim 4, wherein the adjustment capability element comprises contents format element and a conversion method element.

8. The method of claim 4, wherein the translation capability element comprises an original language element, a destination language element, and a language format element.

9. The method of claim 4, wherein the addition capability element comprises a holder format element, an added object element, an added object format element, and an added operation element.

10. An apparatus for providing a broadcasting service containing contents, the apparatus comprising:
a metadata generation unit configured to generate contents representations metadata for describing possible representations of the contents; and
an output unit configured to output the contents representations metadata,
wherein the contents representations metadata comprises one or more contents representations description elements which describe a metadata tool defined by a standard specification.

11. An apparatus for providing a broadcasting service containing contents from a service provider to a user, the apparatus comprising:
a metadata generation unit configured to generate an adaptation capabilities metadata for describing contents adaptation capabilities of the service provider; and
an output unit configured to output the adaptation capabilities metadata, wherein the adaptation capabilities metadata comprises at least one of a transmutation capability element, an adjustment capability element, a translation capability element, and an addition capability element.

12. A method for consuming a broadcasting service containing contents, the method comprising:
receiving contents representations metadata for describing possible representations of the contents; and
selecting contents to be provided to a user by using the contents representations metadata,
wherein the contents representations metadata comprises one or more contents representations description elements which describe a metadata tool defined by a standard specification.

13. A method for consuming a broadcasting service containing contents, the method comprising:
receiving an adaptation capabilities metadata for describing contents adaptation capabilities of a service provider; and
selecting contents to be provided to a user by using the adaptation capabilities metadata,
wherein the adaptation capabilities metadata comprises at least one of a transmutation capability element, an adjustment capability element, a translation capability element, and an addition capability element.

14. An apparatus for consuming a broadcasting service containing contents, the apparatus comprising:
an input unit configured to receive contents representations metadata for describing possible representations of the contents; and
a control unit configured to select contents to be provided to a user by using the contents representations metadata,
wherein the contents representations metadata comprises one or more contents representations description elements which describe a metadata tool defined by a standard specification.

15. An apparatus for consuming a broadcasting service containing contents, the apparatus comprising:
an input unit configured to receiving an adaptation capabilities metadata for describing contents adaptation capabilities of a service provider; and
a control unit configured to select contents to be provided to a user by using the adaptation capabilities metadata,
wherein the adaptation capabilities metadata comprises at least one of a transmutation capability element, an adjustment capability element, a translation capability element, and an addition capability element.
